(19) United States
(12) Patent Application Publication
(10) Pub. No.: US 2009/0255391 A1
(43) Pub. Date: Oct. 15, 2009

(54) Mandolin Slicer

(76) Inventors: Lance Hood, Seattle, WA (US); Joshua Stewart, Seattle, WA (US); Clive Koon Yin Wong, San Leandro, CA (US)

Correspondence Address: JOHN R. BENEFIEL, 525 Lewis Street, BIRMINGHAM, MI, 48009, US

(21) Appl. No.: 12/316,261

(22) Filed: Dec. 10, 2008

Related U.S. Application Data
(60) Provisional application No. 61/123,492, filed on Apr. 9, 2008.

(51) Int. Cl. B26D 7/01; B26D 1/02

(52) U.S. Cl. 83/648; 83/856

(57) ABSTRACT

A mandolin slicer having a slicing plate which is selectively adjustable in height on a main body to allow adjustment of the thickness of slices by a supporting platform which swings on pairs of rods to raise or lower the slicing plate and may be locked in any position. Retractable leg and foot supports are mounted to the main body to allow compact stowing of the supports when not in use. Chipper and julienne upright blade sets can be pivoted up on holder frames by movement of a selector slide so as to protrude through slot sets in the slicer plate to be positioned for chipping or julienne slicing. A reversible blade mount holds a V blade or V waffle blade in alternate positions.

### CROSS REFERENCE TO RELATED APPLICATIONS

This application claims the benefit of U.S. provisional application No. 61/123,492 filed on Apr. 9, 2008

### BACKGROUND OF THE INVENTION

This invention concerns slicers and more particularly mandolin type slicers which are comprised of a fixed blade mounted on a main body with a food item positioned on a slicer plate located below the level of the blade and advanced into the blade with sliding motion to cut a slice from the item.

Adjustments in the thickness of the slice have typically involved very limited adjustments, as by removing and reinstalling the plate in an inverted position to change from a thick to thin slice. Other arrangements have involved complex slow adjustment procedures which decrease the convenience of making thickness adjustments.

The main body often has slots on the bottom to facilitate being positioned on bowl edges, which allow the sliced food to be deposited in the bowl. Alternatively, fixed angled leg supports have been added to enable positioning over other collecting vessels, but these angled legs add to the bulk of the slicer.

Various options are sometimes included as for providing julienne or waffle slicing, etc., but these usually involve separate components which must be assembled to the slicer, which is time consuming and inconvenient.

Heretofore, reversible main blades have been provided allowing a straight blade or a waffle blade to be exposed for slicing, but these have been limited to straight blades. V blades are superior but a reversible V blade has not heretofore been provided due to the difficulty in accommodating the length of the V blade geometry.

Vertical chipper or julienne blades have heretofore been devised for cutting a potato into french fries or other vegetables into julienne strips but these also have been complex and rendered inconvenient to use by the need for assembly of a chipper or julienne blade set into the slicer.

Safety holders for the item to be sliced have been provided but these have been complex or not suited to be guided on the slicer body.

It is the object of the present invention to provide a simplified and compact mandolin slicer which provides all of the features discussed above in an improved way and with self contained components to create greater convenience for the user and reduce the bulk of the slicer.

### SUMMARY OF THE INVENTION

The above recited object and other objects which will be understood upon a reading of the following specification and claims are achieved by a mandolin slicer which self stores a pair of straight legs, at one end of an elongated slicer main body. The pair of legs is locked at an angle to the main body and is self-stored by being unlocked and is pivoted up to a stowed position extending along the outside of either side of the body.

Shorter legs may be provided at the other end of the main body may pivoted up and locked in a stowed position or nonskid pieces may be attached to the other end of the main body.

Another feature allows convenient slice thickness adjustments by providing a slicer plate assembly, with the slicer plate supported by being pivoted at a far end from a main blade or alternatively end or on a linkage comprised of swing rods. The slicer plate can be pivoted or raised to a number of selected positions by rotating an adjustment knob assembly and locked in any selected position to set the height of the end slicer plate and thereby the slice thickness. The knob assembly includes a knob core fixed to one rod end.

The outer knob is slidable on the knob core and interfit therewith so that turning the outer knob turns the knob core which rotates a cam rod to pivot up or down the left platform alternatively, the knob core swings the swing rods and raises or lowers slicer plate. The outer knob is spring biased to engage the fixed tooth set and lock the rods in a selected angular position which sets the slicer plate at a given level. By pulling the knob out of engagement with the fixed tooth set, the knob can be rotated which also rotates the knob core and attached rod to pivot the slicer plate to another level. Upon release of the knob, it again engages the fixed tooth set to fix the slicer plate in the new position. This allows a friction free rapid thickness adjustment to be readily made, with relatively fine increments of adjustment made possible corresponding to the number of radial teeth on the core formed with radial tooth set engageable with a fixed tooth set on one side of the main body.

The main V blade is mounted on one end of a removable blade holder frame with a V waffle blade on the other end, allowing either to be presented to cut slices by reversing the orientation of the frame when installed through a slot in the main body. The blades are offset from each other so that the blade not used extends beneath the fixed connector piece of the main body behind the V blade in cutting position. A guide edge along the connector piece guides the holder frame to maintain a proper orientation during installation.

Chipping and julienne cutting is quickly set up by an array of vertical julienne and chip cutting blades mounted on respective chipper and julienne pivot frames disposed beneath the main slicer plate, the blades of each set aligned with corresponding patterns of slicer plate slots. An adjustment slide forces either the chipper or both frames to selectively be lifted to an up cutting position.

With the chipper blades raised and the slicer plate lowered for maximum thickness french fries are produced. With the julienne's blades also elevated and the slicer plate partially raised julienne slicing is produced.

The main slicer plate can be raised above the main blade for safety which also prevents the chipper and julienne blade sets from being exposed even in their swing up position.

An improved safety slicer holder is also provided which does not involve a spring element. A cup shaped pusher base defines a cavity receiving the item to be sliced, and an inverted cup shaped lower grip with downwardly projecting pins is pushed down to cause the pins to penetrate and hold the item. An upper grip also inverted cup shaped has segments passing through the lower grip to an attached engagement plate pressed against the item. As slicing progresses, the item is gradually stripped from the pins as the upper grip engaged by the palm of the user is pushed down. The lower grip is then engaged by the user's palm to be pushed down to continue slicing, in a two stage motion of the upper and lower grips.

### DESCRIPTION OF THE DRAWING FIGURES

FIG. 1 is a pictorial view of a mandolin slicer according to the invention in the closed or stowage condition.

FIG. 2 is a pictorial view of the mandolin slicer shown in FIG. 1 from the opposite side.

FIG. 3 is a pictorial view of the mandolin slicer shown in FIG. 2 from a point beneath the main body.

FIG. 4 is an enlarged longitudinal sectional view of the mandolin slicer shown in FIGS. 1-3.

FIG. 5 is a pictorial view of the mandolin slicer shown in FIGS. 1-4 with the leg and pivot foot sets lowered and a waffle blade installed in the cutting position.

FIG. 6 is a pictorial view of the mandolin slicer as shown in FIG. 5 with the chipper blades raised to a cutting position and the slicer plate in the full down position.

FIG. 7 is a pictorial view of the mandolin slicer as shown in FIG. 6 with both the chipper and julienne blades raised and slicer plate partially raised for julienne slicing.

FIG. 8 is a lengthwise sectional view of the mandolin slicer shown in FIG. 5, but with the main V blade installed.

FIGS. 9A-9C are pictorial views of the chipper and julienne blade frames and adjuster slide in the both fully raised position, the chipper blade frame only raised, and both lowered positions respectively.

FIGS. 10A and 10B are pictorial views of the lift platform assembly in the fully raised and fully lowered position respectively.

FIGS. 11A and 11B are enlarged fragmentary partially sectional views of the knob core connected rod end and outer knob in the locked and unlocked positions respectively.

FIG. 11C is a sectional view taken through the rod, knob core and outer knob.

FIGS. 12A and 12B are pictorial fragmentary views of a central region of the main body with the blade mount frame removed and installed respectively.

FIG. 13 is a pictorial view of the blade mount frame showing the slicing blade and waffle blade at respective ends.

FIG. 14 is a partially exploded view of one end of the main body and the adjuster platform included in the mandolin slicer shown in FIG. 1 together with the slicer handle.

FIG. 15 is a longitudinal sectional view of the main body.

FIG. 16 is a pictorial view of the slidable leg piece included in the mandolin slicer shown in FIG. 15.

FIG. 17 is an enlarged fragmentary pictorial of the underside of one end of the mandolin slicer of FIG. 1 showing details of the front foot and foot lock.

FIG. 18 is a sectional view of the safety pusher included in the mandolin slicer shown in FIG. 1, showing the outline of a vegetable in position for slicing thereon in broken lines.

FIG. 19 is a longitudinal section through another embodiment of a slicer incorporating improved details.

FIG. 20 is a pictorial underside view of a modified slicer plate and lift platform incorporated in the embodiment shown in FIG. 19.

FIG. 21 is a pictorial view of another embodiment of the mandolin slicer according to the invention set up for slicing.

FIG. 21A is a pictorial view of the embodiment shown in FIG. 21 in a folded condition for storage.

FIG. 22 is a pictorial view from the bottom of the mandolin slicer shown in FIG. 21.

FIG. 23 is a pictorial view from the bottom of the slicer plate and adjustment cam rod and knob assembly included in the mandolin slicer shown in FIG. 21.

FIG. 23A is a pictorial view of the slicer plate shown in FIG. 23 without the cam rod.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

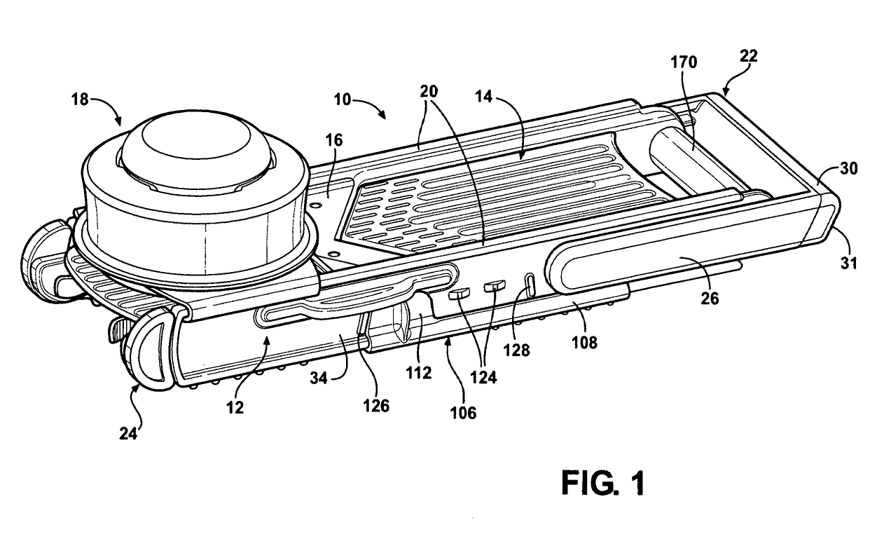

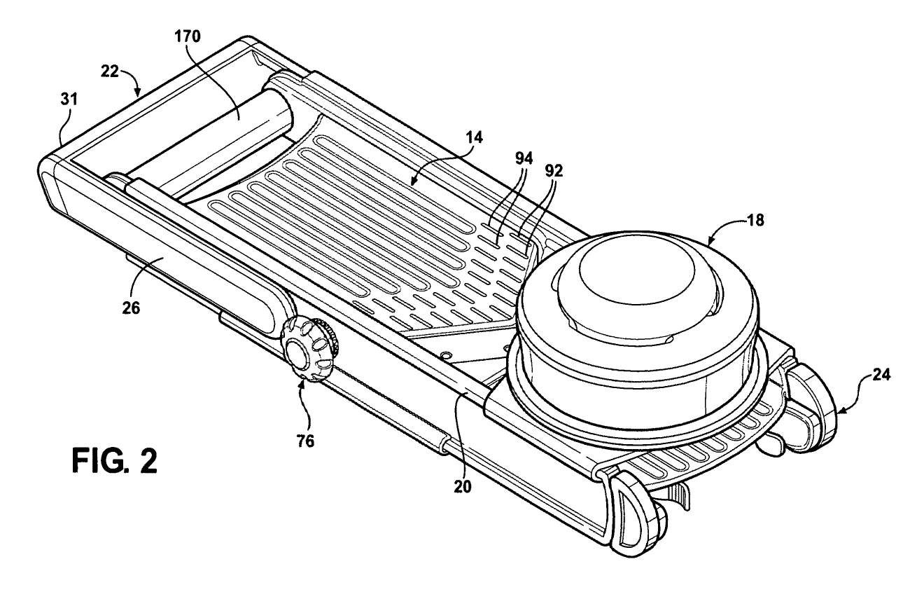

Referring to the drawings, and particularly FIGS. 1, and 5-4, a mandolin slicer 10 according to the present invention is shown, and includes the major components of a conventional mandolin slicer.

A generally rectangular main body 12 supports a ribbed slicer plate 14, able to be raised and lowered as described herein on which an item to be sliced (not shown) is positioned to be slid into a V-shaped cutting blade 16 positioned above the level of the slicer plate 14 a variable distance corresponding to the desired thickness of the slices to be cut.

A safety holder assembly 18 engages the item during slicing (but is shown in a stored position on the left) and may be held on slide rails 20 formed on the main body 12 to be guided as the safety holder assembly 18 is stroked repeatedly to cut slices from the item in the well known manner.

According to one feature of the present invention, the main body 12 has a slidable leg piece 22 mounted thereto and a pivoted front foot assembly 24 at the other end.

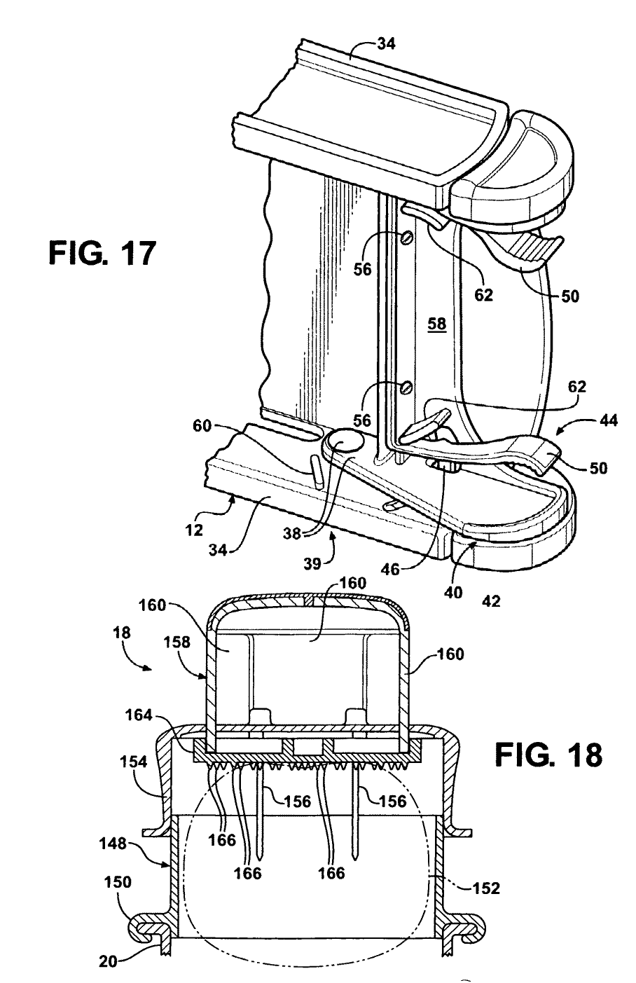

The slidable leg piece 22 is generally U-shaped, having a pair of spaced apart parallel leg members 26 straddling the main body 12 in the stowed position shown in FIG. 1, each formed with a guide pin 28 at their free ends (FIG. 16).

A cross member 30 may have a soft non-skid cap 31 over molded thereto.

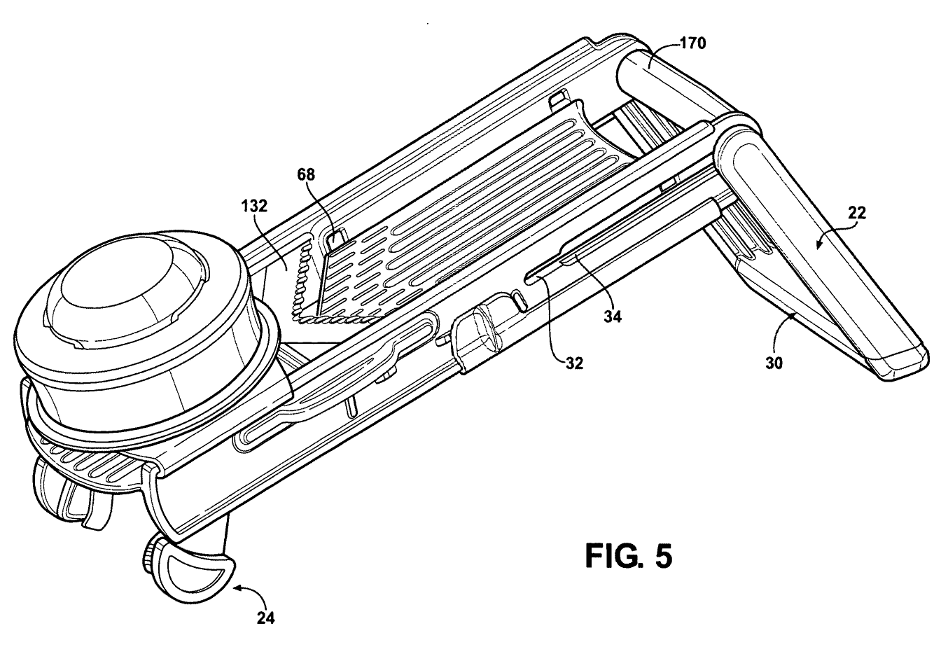

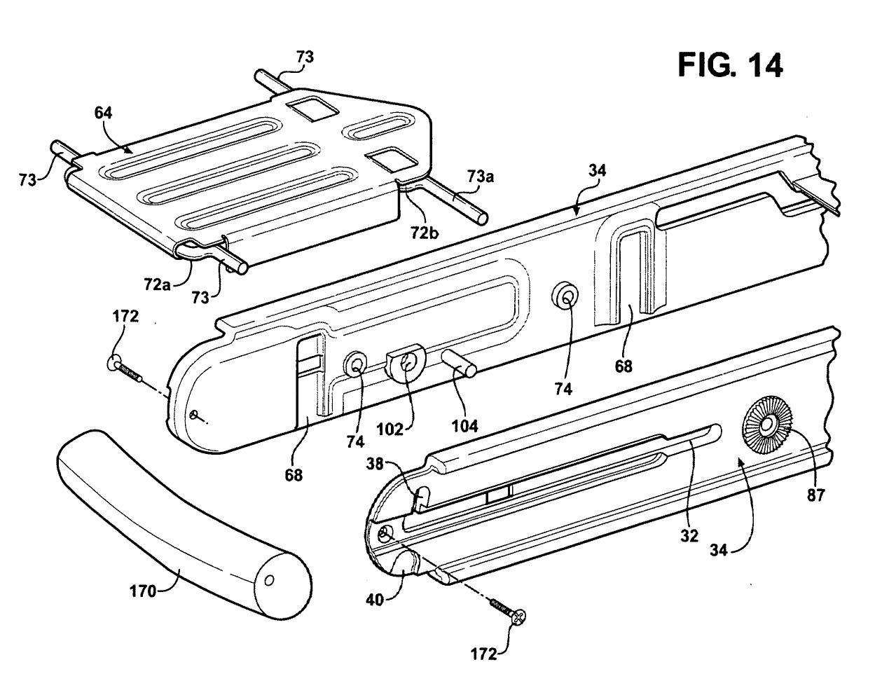

A groove section 32 in the outside of each side member 34 of the main body 12 receives a respective one of the guide pins 28 with a wider groove section 34 receiving a raised rib 36 on the members 26 aligned with each pin 28 to hold the leg piece 22 aligned with the main body 12 in the stowed position. A recess 38, 40 at the outer end of each of the slots 32 receives the pins 28 and the curved end of the ribs 36 respectively. This allows fixing the sliding leg piece 22 (FIG. 14) to be held at an angle after pulling the sliding leg piece 22 straight out of the main body 12 and turned at an angle to provide a support of that end of the main body (FIG. 5).

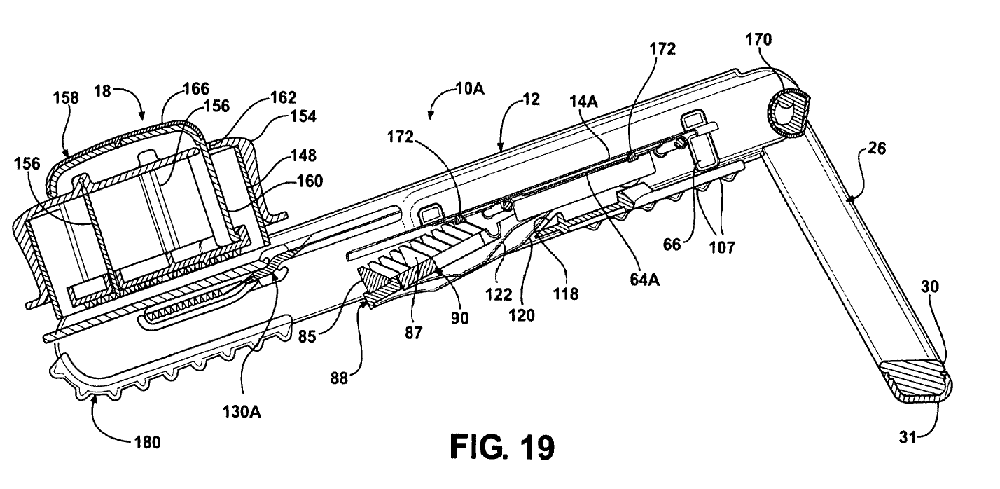

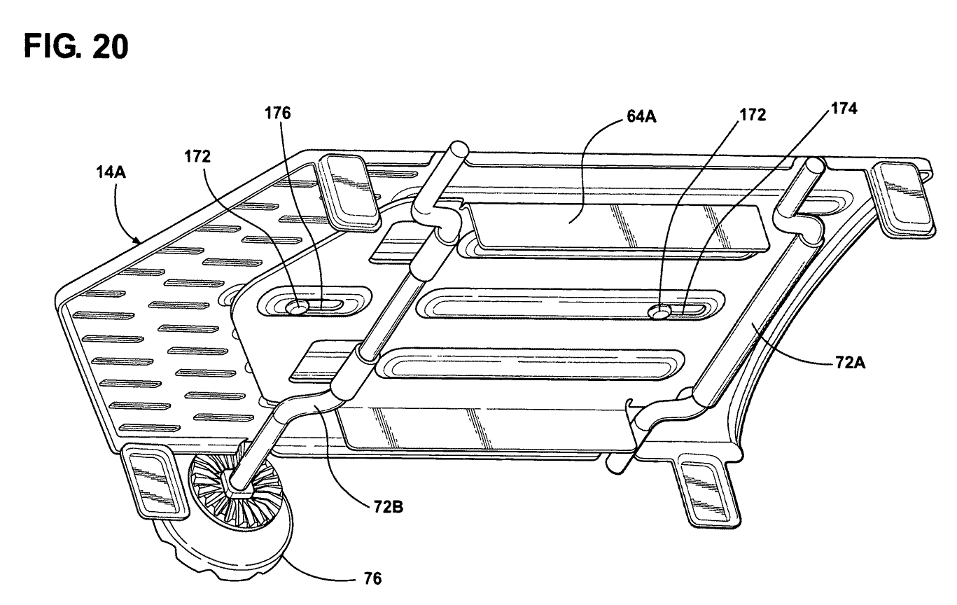

The front foot assembly 24 has pivot pins 38 passing through a respective ear portion 39 of each front foot 40 (FIG. 17) and received in a respective hole 41 in each side member 34 at the front end of the main body 12. This allows the feet 40 to be swung down to provide a lower support for the main body 12 (FIG. 5). An overmold 42 of softer plastic can be added to each front foot 40.

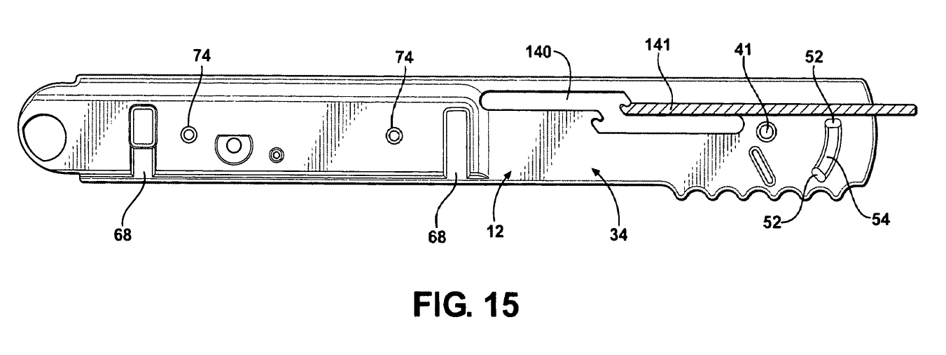

A front foot lock element 44 has a pin 46 projecting from each of a pair of fingers 50 which may be received in holes 52 at either end of curved grooves 54 formed in main body side members 34 (FIG. 15). The locking element 44 is attached to the front foot assembly 24 by integral split pins 56 received in holes in the front foot cross member 58.

Stop webs 60 limits pivoting motion, while webs 62 prevent squeezing fingers 50 together too far (FIG. 17).

When fingers 50 are squeezed together, the pins 46 are withdrawn from holes 52, allowing pivoting motion of the front foot assembly 24 to the position shown in FIG. 5, and vice versa. Release of the fingers 50 to allow pins 46 to enter holes 52 locks the front foot assembly 24 in position at either end of the curved grooves 54.

The slicer 10 is thus positioned in an inclined manner over a planar support (not shown) with both leg piece 22 and front foot 24 deployed.

Another important feature of the present invention is the quick and easy adjustable positioning of the slicer plate 14 to enable slice thicknesses to be varied without the need for removal or assembly of separate parts.

This is accomplished by motion of a lift platform 64 mounted below the slicer plate 14 so as to support the same. The slicer plate 14 itself is guided to be vertically movable on the main body 12 by four tabs 66 affixed at the front and back of each side of the slicer plate 14 slidable in slots 68 in the inner face of each of the sides 34 of the main body 12.

The lift platform 64 is attached to a pair of parallel pivot rods 72A, 72B, which each have a pair of opposite offset ends 73A, 73B pivotably received in socket holes 74 in each side 34 of the main body 12 to allow the rods 72A, 72B to be swung to raise or lower the lift platform 64 and with it the slicer plate 14.

The rear pivot rod 72B has an adjuster knob assembly 76 attached on the longer rod end 72B projecting through one side 34 of the main body 12. The knob assembly 76 includes an outer knob 78 which has an inner face 75 which has a set of radial teeth which can be meshed with a fixed, radially toothed disc 74 formed integrally on one side 70 (FIG. 5) of the main body 12.

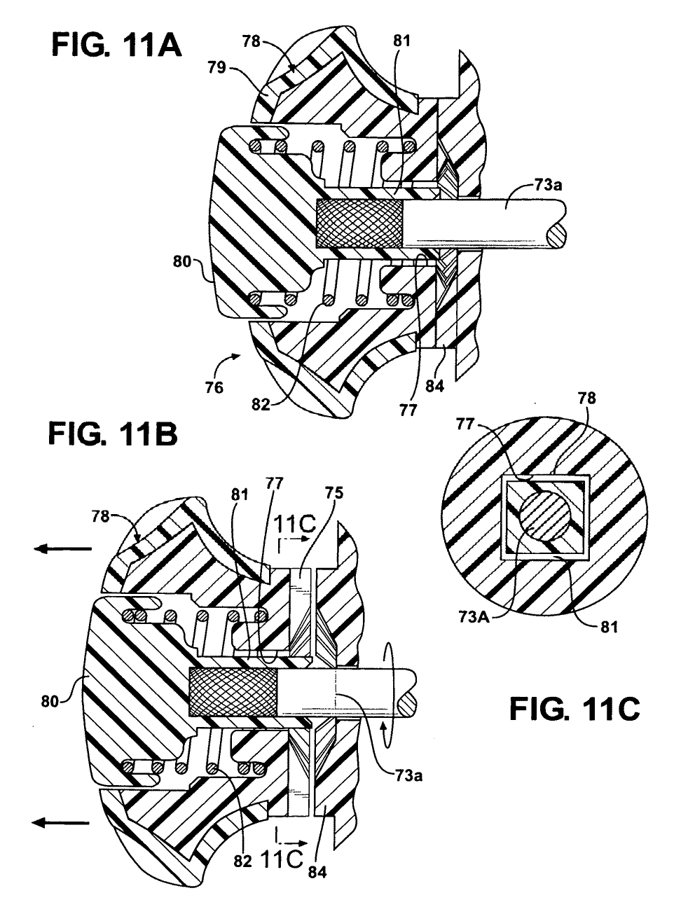

The knob assembly 76 includes a knob core 80 fixedly attached to the projecting end 73B of the pivot rod 72B (FIGS. 11A-11C). A coil spring 82 is interposed between an outer knob 78 and knob core 80 urging the outer knob 78 teeth into engagement with the fixed toothed disc 84. The outer knob 78 may have a soft material overmold 79 (TPE) for better gripping.

The knob core 80 has a square in section end 81 while the outer knob 78 has a slightly larger square opening 77. This creates a rotary connection between the knob core 80 and outer knob 78 while allowing relative axial movement between the knob core 80 and the outer knob 78

By retracting the outer knob 78 against the pressure of the spring 82, the radial teeth 75 on the outer knob 78 and disc 84 can be disengaged and the outer knob 78 released to be able to be rotated to swing the rods 72A, 72B to a position corresponding to a height of the lift platform 64 corresponding to a desired height of the cutting plate 14. When the outer knob 78 is released, the teeth 75 reengage and lock the lift platform 64 in the selected position.

This positions the cutting plate 14 resting on the lift platform 64 at the height producing a desired slicing thickness. The low friction of the moving parts and the positive fixing of the outer knob 78 in any adjusted position are a distinct improvement over prior designs.

The mandolin slicer also includes julienne and chip cutter blade V arrays 85, 87 which can be easily and quickly moved into and out of cutting positions.

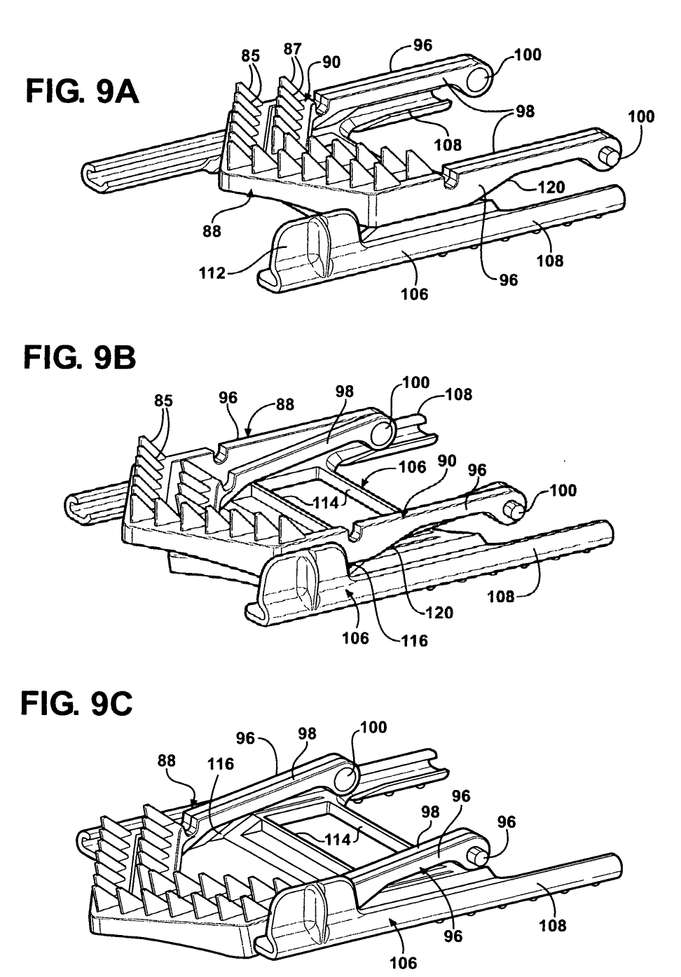

As seen in FIGS. 9A-9C, the julienne and chipper blades 85, 87 are arranged in sets offset from each other with the chipper blades 87 located forward of the julienne blades 85, projecting upright on a chipper frame 88 and julienne frame 90 respectively. The blades 85, 87 are made in U-shaped stainless steel pieces molded into the ends of the frames 88, 90.

The cutting plate 14, located over the chipper blades 85 and the julienne blades 87, has two series of offset slots 92, 94 sized and spaced to allow the blades in arrays 85, 87 to be selectively raised above the surface of the cutting plate 14 by swinging up the corresponding frames 88, 90.

The frames 88 and 90 are generally U-shaped, each with a pair of parallel arms 96, 98 all pivotally mounted about a common axis defined by pivot pins 100 passing through holes in one of the ends of the arms 96, 98 and pressed into a hole 102 on each side 34 of the main body 12 (FIG. 14). The arms 96, 98 are spaced apart so that arms 98 are nested within the arms 96. Projections 104 (FIG. 14) provide a down stop for the arms 96, 98.

The frames 88 and 90 are raised by engagement with a selector slide 106 having open elongated parallel guides 108, received on lower slides 110 on the lower edge of each side member 34.

The slide 106 has an upwardly projecting finger grip 112 facilitating movement of the slide 106 back and forth.

The slide guides 108 are connected by cross piece 114.

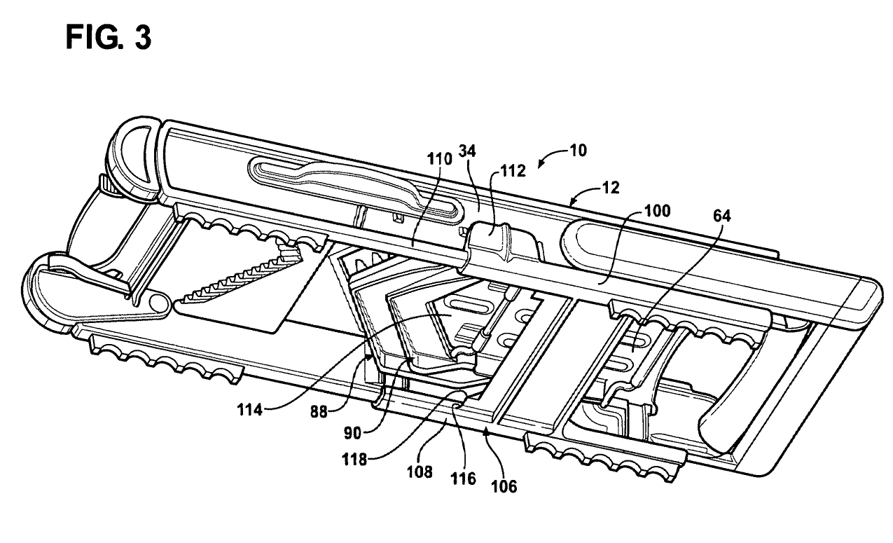

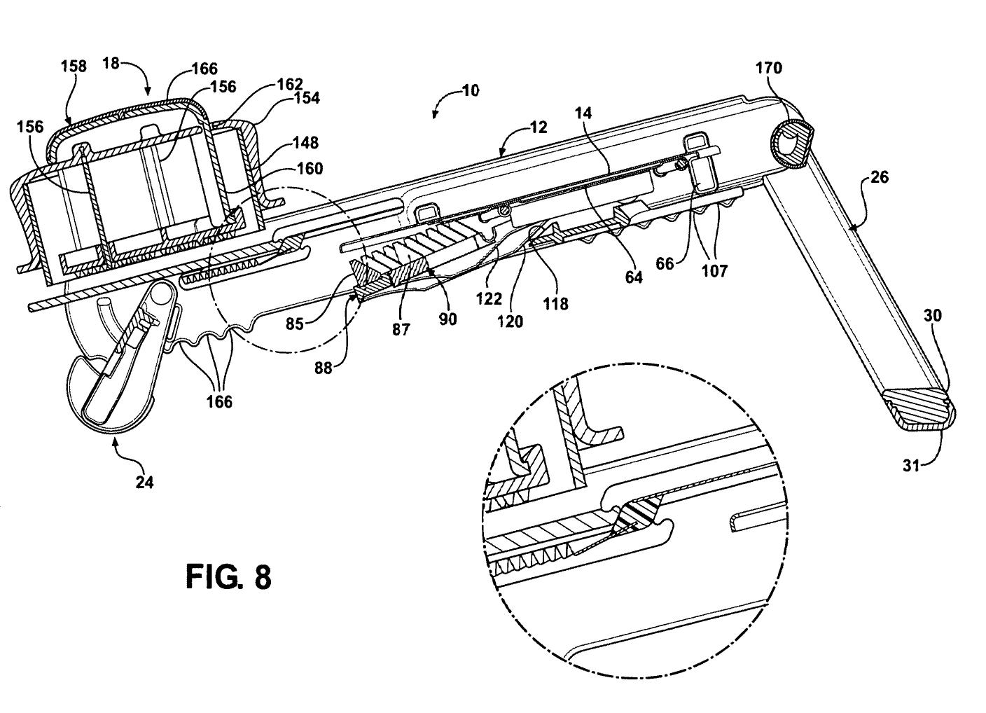

Two sets of sloping cam surfaces are found on the slides 106, an outer set 116 and an inner set 118, which are each aligned with a respective set of sloping surfaces 120, 122 on the arms 96, 98 (FIGS. 3, 8 & 9A-9C).

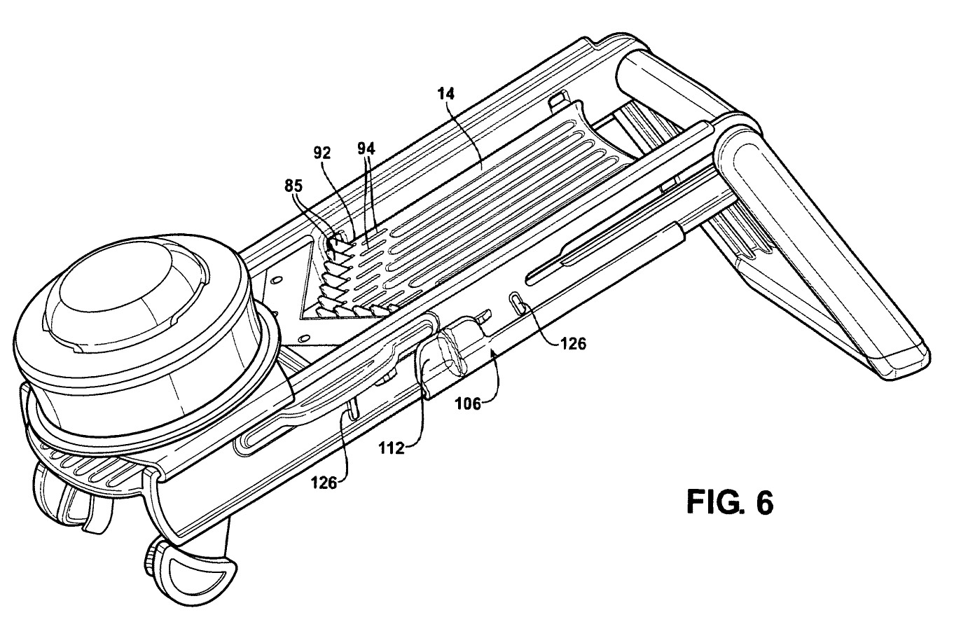

When the slide 106 is advanced to the left to a centered position as seen in FIGS. 9A, 9B the chipper blades 85 are elevated by engagement of surfaces 116, 120 and consequent swinging up of frame 88. This is the chipping position which will slice a vegetable into strips of a width defined by the spacing of the blades 85 and depth set by the height of the slicer plate 14 (FIG. 6), normally at full down when chipping.

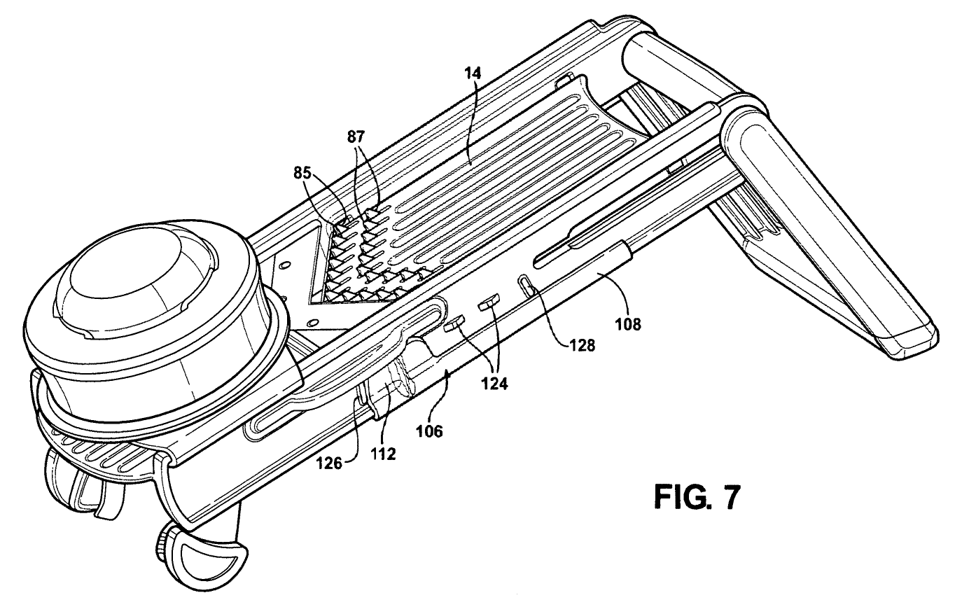

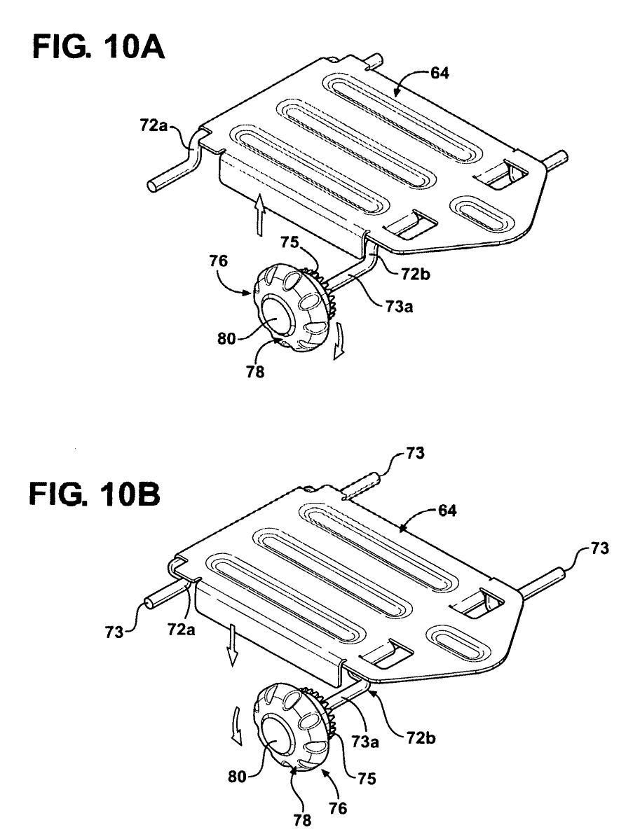

Upon further advance of the slide 106, the julienne blades 86 are elevated by engagement of surfaces 118, 122 and consequent pivoting up of the inner frame 90 as seen in FIGS. 10C, 10D. This produces cutting of thinner julienne strips since both blades 84, 86 will cut a vegetable stroked over the blades 85, 87, rather than only one set as in the chipping position. The slicer plate 14 is raised to a shallower depth as seen in FIG. 7.

The finger grip portion 112 engages detent features 124 on the main body side 34 which allows detection of the slide 106 being in the centered position between detent features 124 on one side 34 of the main body 12.

An up stop 126 prevents movement of the slide 106 beyond the point where both blade sets are in the up position and a down stop 128 prevents movement past an all down position of the slide 106 to the right, wherein both slide blades 85, 87 are in their lowered position with the slide 106 fully moved to the right as seen in FIGS. 6 and 9C. The exposure of the blades 85, 87 is also partly controlled by the level of the slicing plate 14. In the chipping position, FIGS. 6 and 9B, the slicer plate 14 is lowered to its lowest position for maximum exposure of the chipper blades 85.

In the julienne position of FIGS. 7 and 9C, the slicing plate 14 is positioned at its centered intermediate level to only partially expose both blades 85, 87.

Thus, the main V blade 16 cuts the strips thicker in the chipping position (FIG. 9B) and thinner in the julienne position of FIG. 9C.

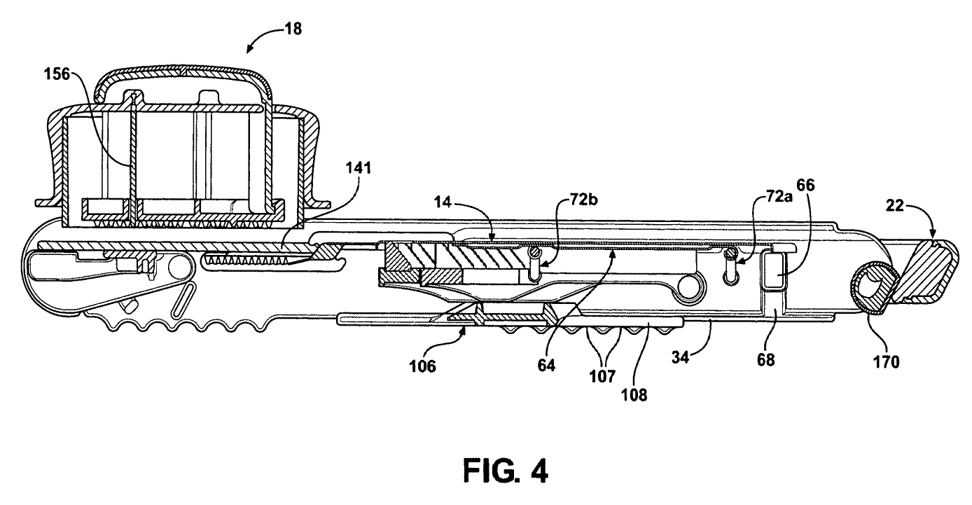

The bottoms of the slide guides of the slide 106 are formed with scallops 107 along the bottom sides to engage a bowl rim (FIGS. 4, 8).

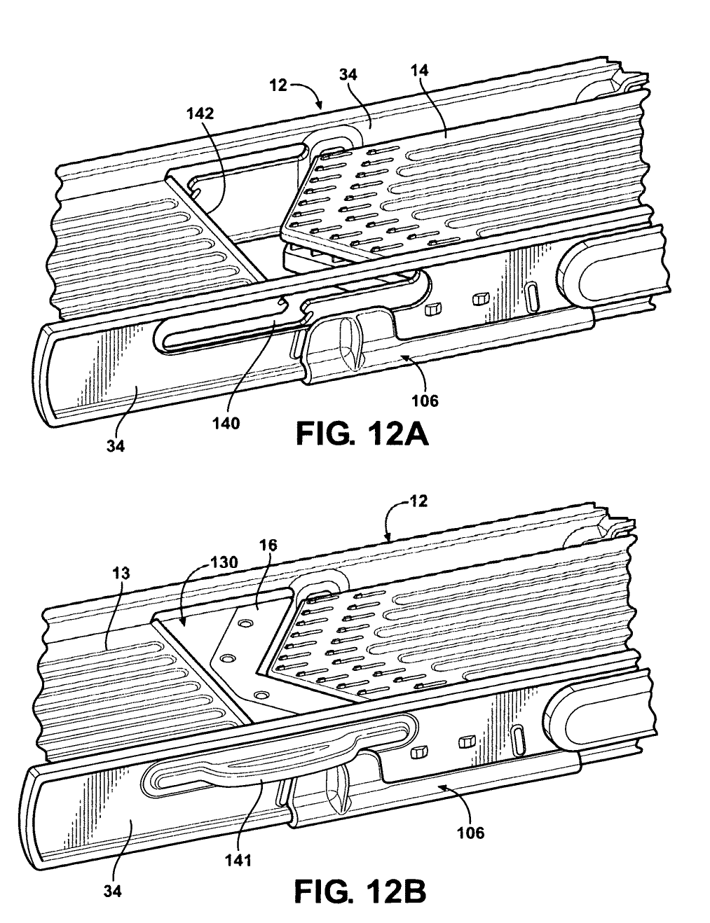

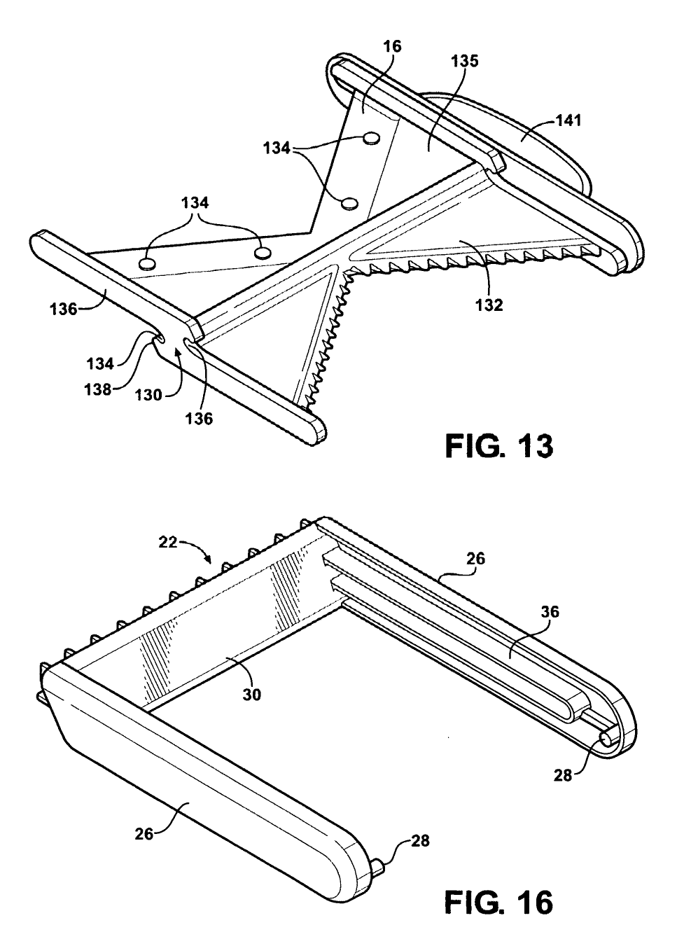

Another feature of the invention provides a reversible main blade holder 130, (FIGS. 12A, 12B, 13) Which is installed in the main body 12 in either of two reversed orientation so as to expose either or the main V blade 16 or a V waffle blade 132 facing towards the slicer plate 14. The main V blade 16 is heat staked at 134 to cross piece 135 to be affixed to the holder frame 130 while the waffle blade 132 is molded into the plastic. The holder 130 has side walls 136 formed with rounded protrusions 138 which extend across the holder 130.

These rounded protrusions 138 are matched to an opening 140 in one side of the main body 12 as seen in FIG. 12A.

The main blade holder 130 has vertically offset sections, each holding a V blade 16, 132. The blade not in cutting position is stored beneath the fixed rear platform 141 connecting the two sides 34 of the main body 12 together (FIG. 4) to accommodate the relatively long V blade holder 130 required.

The holder 130 is inserted into the opening 140 (FIGS. 9A, 15) holding the grip 141 on one side (after the slide 106 moved to the right to be out of the way) with the desired blade 16 or 132 facing to the right. A guide rail 142 (FIG. 12A) extends along a rear deck and connecting the two sides 34 of the main body 12 engages hollow 144 or 146 defined above protrusions 138. This guides the movement of holder 130 as it inserted to make insertion easier by preventing tipping and wedging of the holder 130.

The safety holder assembly 18 (FIGS. 1, 4, 8 and 19) may be of a general type well known in the industry, and includes a cup shaped base holder 148 having hooked appendages 150 formed to engage the guide rails 20 and sides 34 of the main body 12. The interior space can receive a vegetable or fruit item 152 to be sliced. An inverted cup shaped bottom grip 154 is slidable on the base 148 and has a series of holder pins 156 insert molded therein.

A slightly small diameter top grip 158 has three arcuate segments 160 passing through arcuate slots 162 in the top of the bottom grip 154. A pusher face 164 having sharp protrusions 166 facing down is snap fit to the bottom of the top grip 158.

A soft overmolded cover 166 can be included on the top grip 158.

With the fruit or vegetable 152 in the base holder 148, the safety holder 18 is gripped and reciprocated across blade 16 or 132 to slice the item 152, with the pins 156 penetrating the same for a secure hold.

The protrusions of pusher face 164 engage the item 152 during slicing. As the item 152 is sliced, it is gradually stripped from the pins 156 by the down pressure exerted by the user's palm on the top grip 158, eventually being completely retracted so that the pins 156 are never contacted by the cutting blades 16 or 132.

Continued pressure is exerted on the lower grip thereafter to continue to force the item 152 down to continue the slicing in a staged manner. The top grip 158 is of a diameter (about 3 inches) to enable hand pressure to be conveniently applied. Thus, the top grip 158 and bottom grip 154 are depressed, i.e., the top grip is telescoped down onto the bottom grip 154, which then is telescoped down into the holder 148.

The main body 12 is also provided with a series of scallops 168 (FIG. 8) at the end opposite from the scallops 107 to allow engagement with the rim of a bowl.

A curved handle 170 is mounted to the end of the main body 12 using screws 172 (FIG. 14).

The handle 170 may be molded of ABS plastic and overmolded with softer TPE providing a secure and comfortable grip

Accordingly, the mandolin slicer 10 described offers a number of convenience features while being compact and easy to use.

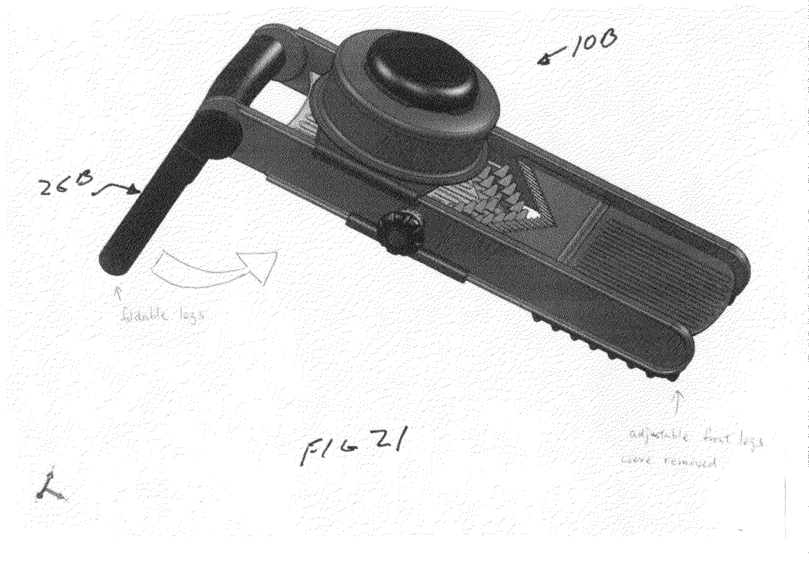

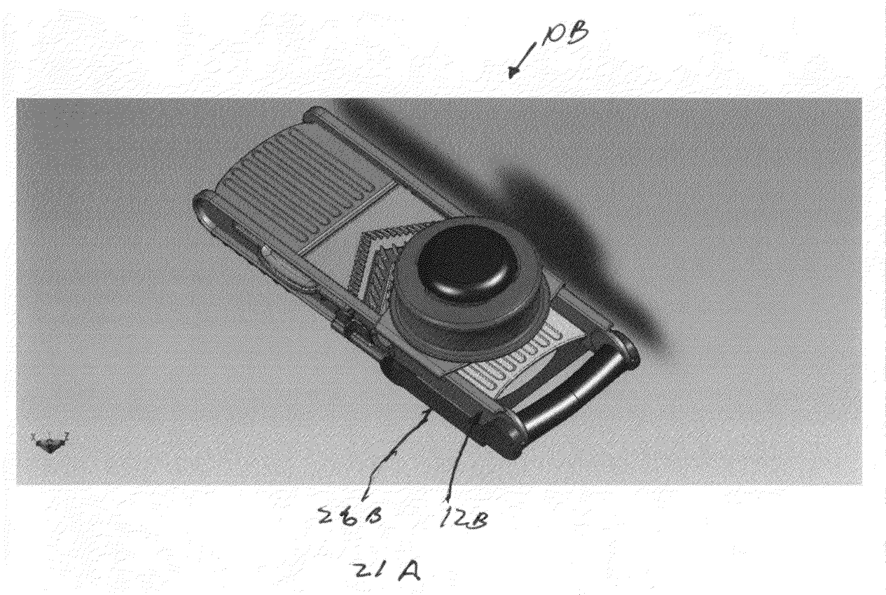

In order to minimize any tendency for slicer plate to tip on the lift platform, a pin and slot connection may be provided as seen in the mandolin slicer embodiment 10A shown in FIGS. 19 and 20.

A pair of headed pins 172 are attached to the slicer plate 14A and received in slots 174, 176 formed in central ribs of the lift platform 64A. The heads of the pins 172 are larger than the slots 174, 176 to act to restrain the slicer plate 14A from lifting or tipping up from the lift platform 64A while accommodating the relative sliding motion occurring during adjustment of the height of the slicer plate 14A as the rods 72A, 72B are swung by turning of the knob assembly 76.

In addition, the geometry of the blade holder 130A is stretched out so that a slice from an item being sliced will not make contact with the holder 130A as it comes off the V blade. Such contact could affect the neatness of the slice by forcing a leading edge down as slicing is completed which would be exacerbated by tipping of the slicer plate on the lift platform.

Finally, the front foot assembly 27 can be replaced by a pair of clip on non-skid pieces 180 formed with scallops 182 for engaging a bowl rim. This takes up less space and accommodates the longer blade holder 130A.

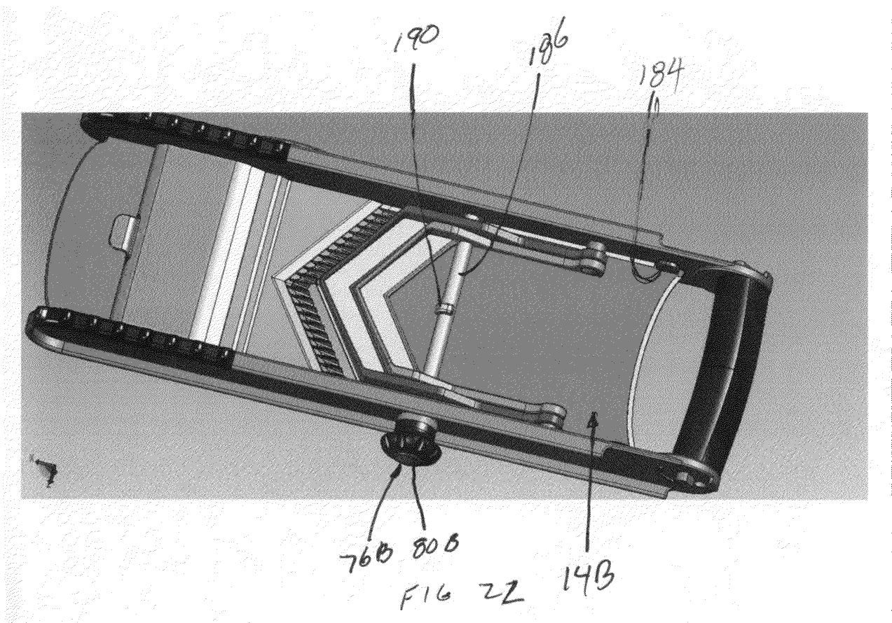

FIGS. 21 and 21A show another alternative embodiment of a mandolin slicer 10B. In this embodiment, the front legs 26B are simply pivoted at one end and are stewed in a swung up position beneath and end of the main body 12B as seen in FIG. 21A.

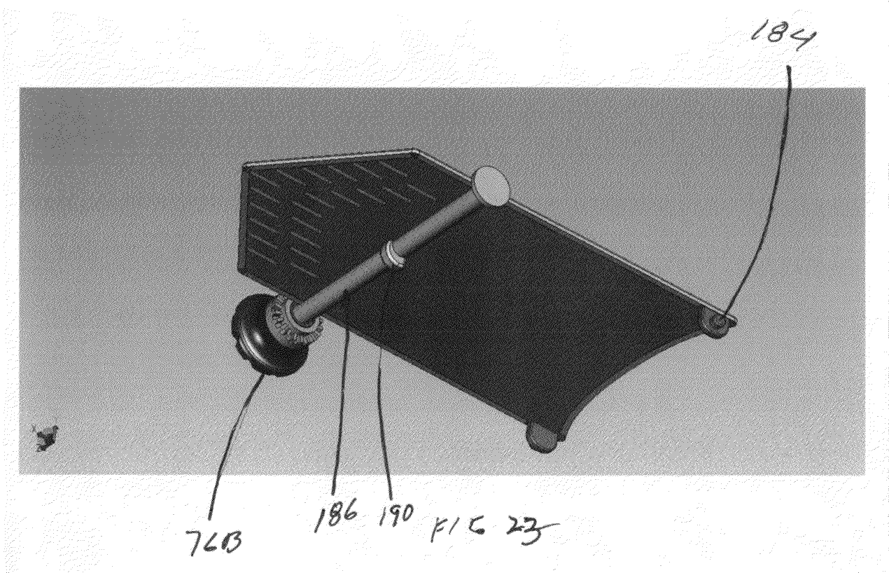

An important difference is the elimination of the separate lift platform and the pivoted mounting of the slicer plate 14B at an end opposite the main blade by pivots 184 (FIG. 22).

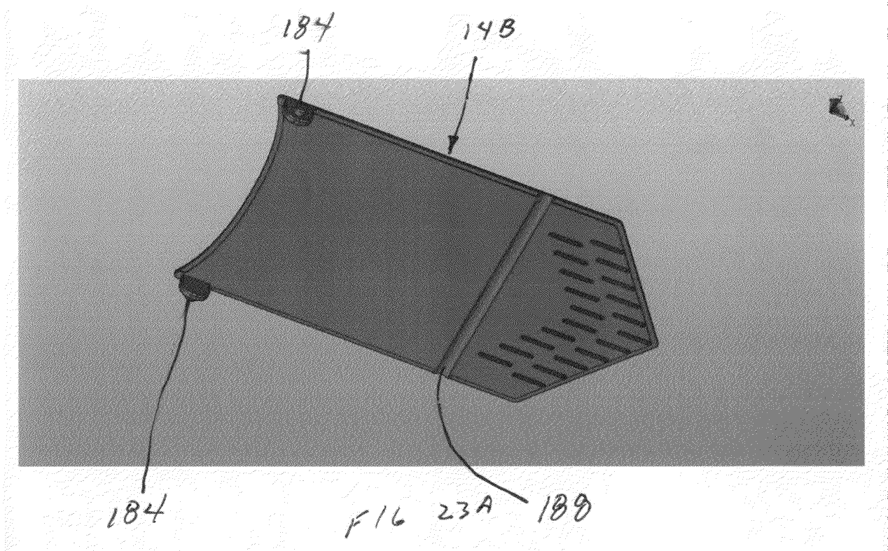

The knob core 80B of the knob assembly 76B is connected to a cam rod 186 (FIG. 23) received in an arcuate depression 188 formed in the bottom of the slicer plate 14B (FIG. 23A). A spiral cam 190 is affixed to the cam rod 186.

Rotation of the cam rod 186 by the knob assembly 76B (FIG. 23) causes the end of the slicer plate 14B to be swung up or down by the cam 190 to adjust the slice thickness.

1. A mandolin slicer comprising:
a main body;
a cutting blade mounted to said main body;
a slicing plate also mounted to said main body having an upper surface located to one side of said cutting blade for supporting an item to be sliced by advancement against said cutting blade;
said slicing plate mounted for movement on said main body relative to said cutting blade to change the level of said slicer plate at said cutting blade;
an adjustment mechanism supporting said slicing plate to be selectively positioned at any of a number of selected levels relative said cutting blade, whereby the thickness of slices can be adjusted by operation of said adjustment mechanism.

2. The mandolin slicer according to claim 1 wherein said slicer plate is pivoted to said main body at an end away from said cutting blade and wherein operation of said adjustment mechanism raises or lowers the other end of said slicer plate relative said cutting blade.

3. The mandolin slicer according to claim 2 wherein said adjustment element comprising a knob drivingly connected to an end of a cam rod to rotate therewith;
said cam rod having a cam affixed thereon engaging said slicer plate to raise or lower said other end thereof.

4. The mandolin slicer according to claim 3 wherein said knob has a radially toothed face engaged with an axially mating fixed radial teeth on said main body when released to lock said knob against rotation.

5. The mandolin slicer according to claim 4 wherein said knob is axially moveable away from said fixed teeth against the force of an axially acting spring urging said knob into engagement with said fixed disc, whereby said knob can be pulled away from said fixed teeth and rotated to rotate said cam rod to a selected position and thereafter allowed to move axially to engage said fixed teeth to lock said cam rod in said selected position, and thereby secure a selected height of said other end of said slicing plate relative said cutting blade.

6. A mandolin slicer comprising:
a main body;
a cutting blade supported on said main body;
a slicing plate mounted on said main body to locate a main upper surface adjacent but below said cutting blade so that an item to be sliced can be slid along said slicing plate and into said cutting blade to slice said item;
said slicing plate having a set of slots formed therein in a pattern extending across said slicer plate in the same direction as said cutting blade;
a set of upright blades arranged in a pattern matching said slot pattern and a block holder frame pivotally mounted on said main body below said slicing plate so as to allow said upright blades to be pivoted up and received into said slots to protrude above an upper surface of said slicing plate; and,
a slide mounted on said main body to be movable into engagement with said holder frame so as to pivot said holder frame up thereby selectively exposing said upright blades above said slicing plate and enable slicing a portion of said item into strips with subsequent slicing by said cutting blade.

7. The mandolin slicer according to claim 6, further including a second set of slots behind said first recited set of slots in said slicing plate arranged in a pattern extending across said slicing plate offset from said pattern of said first set of slots behind said first recited set of slots, and second set of upright blades arranged in a pattern matching said second set of slots mounted on a second holder from pivotally mounted on said main body below said slicing plate so as to allow said second set of upright blades to be moved up into said second set of slots to protrude above said slicing plate surface;
said slide successively engageable with said first and second holder frames upon continued sliding motion whereby said second set of blades can be positioned protruding above said slicing plate upper surface by movement of said slide, or both of said set of upright blades positioned above said slicing plate upon continued movement of said slide.

8. The mandolin slicer according to claim 7 wherein said slicer plate is mounted to be movable on said main body to an adjustable level relative said upright blades to vary the height of said upright blades relative thereto.

9. A mandolin slicer comprising:
a main body;
a cutting blade mounted on said main body;
a slicing plate having an upper surface mounted on said main body below and to one side of said slicing blade so as to support an item to be sliced thereon and advanced into said cutting blade and sliced thereby;
a pair of elongated members connected at one end and having protruding portions on other ends thereof guided in a respective elongated slot in each side of said main body to allow a retracted positioning of said members alongside a respective side of said main body, said slots and protruding portions being configured to allow said members to be held parallel to said main body until being moved out to the ends thereof and thereafter pivoted down to extend at an angle to said main body to provide a support therefore at one end.

10. A mandolin slicer according to claim 9 further including a foot pivoted to another end of said main body to be rotated up to a stowed position or swung down to a position supporting said other end of said main body.

11. The mandolin slicer according to claim 10 further including a locking element selectively locking said foot in either said stowed or supporting position.

12. A holder assembly for holing an item for slicing in a mandolin slicer comprising:
an item base cup open at a bottom end to allow an item placed therein to be exposed at the bottom for slicing a cutting blade mounted in said mandolin slicer;
an inverted cup shaped bottom grip telescoped onto said base cup and having a plurality of spikes projecting down into said base cup;
a generally cup shaped top grip comprised of a series of arcuate segments projecting through arcuate slots in a top of said bottom grip and a pusher piece attached to the bottom of said arcuate segments, said pusher piece having holes therein each aligned with and receiving a spike.

13. A holder assembly according to claim 12 wherein said mandolin slicer includes a main body formed with a pair of sides with a slide on the top of each side, said base cup formed with features received on said slides to guide strong movement.

14. A mandolin slicer comprising:
a main body;
a cutting blade mounted to said main body;
a slicing plate also mounted to said main body having an upper surface located to one side of said cutting blade for supporting an item to be sliced by advancement against said cutting blade;
said main body having a pair of sides;
a reversible V blade holder comprising a first segment holding a straight edged V blade and a second segment offset from the first segment and extending in the opposite direction holding a V shaped waffle blade;
said main body sides having an opening in one side removably receiving said V blade holder, with one of said V blades opposite said slider plate.

15. The mandolin slicer according to claim 14 wherein said main body has a cross piece fixed between said sides, one of said segments of said V blade disposed below said cross piece and the other segment located at the same level and forward of said cross piece.

16. The mandolin slicer according to claim 15 wherein said holder has a guide surface extending across the width of said holder engaging a complementary feature on said V blade holder to locate the same.
